(19) United States
(12) Patent Application Publication
(10) Pub. No.: US 2016/0367971 A1
(43) Pub. Date: Dec. 22, 2016

(54) Catalyst and Method for Synthesis of Carbon Nanomaterials

(71) Applicant: Northeastern University, Boston, MA (US)

(72) Inventors: Chuanwei Zhuo, Malden, MA (US); Yiannis Levendis, Boston, MA (US)

(21) Appl. No.: 14/447,196

(22) Filed: Jul. 30, 2014

Related U.S. Application Data
(60) Provisional application No. 61/859,804, filed on Jul. 30, 2013.

(51) Int. Cl. B01J 23/889; C01B 31/02; B01J 35/10; B01J 37/08; B01J 23/26; B01J 35/00

(52) U.S. Cl. CPC B01J 23/8892; B01J 23/26; B01J 35/0006; B01J 35/10; B01J 37/082; C01B 31/0233; C01B 2202/06; C01B 2202/08; B82Y 40/00

(57) ABSTRACT

Methods for activating the surface of steel alloys to produce catalytic substrates for the synthesis of carbon nanomaterials by chemical vapor deposition are provided. Steel alloy substrates in a variety of forms are activated by brief (10 sec to 30 min) pre-treatment at high temperature (600-1000° C.) in an oxidizing environment (e.g., air) to activate the catalyst. Upon high temperature oxidative treatment, the initially smooth and protective chromium oxide coating layer of the steel alloy is destroyed, and the catalyst surface roughness progressively increases. Upon exposure of the pre-treated SS substrates to pyrolyzed hydrocarbon gases in nitrogen, carbon nanotubes are readily formed, and their diameters correlate with substrate surface roughness. Forests of vertically aligned nanotubes can be prepared with the method.

### CROSS REFERENCE TO RELATED APPLICATIONS

This application claims the priority of U.S. Provisional Application No. 61/859,804 filed Jul. 30, 2013 and entitled “Expedient and Cost-Effective Preparation of Catalytic Substrates for Growing Carbon Nanomaterials”, the whole of which is hereby incorporated by reference.

### BACKGROUND

Carbon nanotubes (CNTs) have been studied for more than two decades since their discovery [1-3]. With their increasing commercialization, it is important to integrate CNT processing with existing manufacturing methods [4,5]. Efforts have been made to reduce the major expenditures in CNT production, which are the carbonaceous feedstocks (raw materials), the catalyst, and power consumption. For instance, municipal and industrial waste plastics and process biomass residues have been proposed as low-cost feedstock alternatives, [6-13] and stainless steel (SS) screens or chips have been proposed as cost-effective, dual-purpose substrates and catalysts [14, 15]. Stainless steels contain transition metals (iron, nickel, etc.) which are effective catalysts for CNT growth [16-18]. For instance, type 304 SS is readily-available and reasonably-priced, and its application as catalyst is of interest to CNT manufacturing [6, 15]. Further, SS can be used in templates of various geometries (e.g., porous block [19], wire cloth (mesh) [14], tubing [20], and plate [21,22]), which facilitates applications in which direct interaction between CNTs and conducting substrates is desirable [15,21,23], as well as applications in which template architecture can serve as a device structure [24,25].

However, SS does not readily react with the gaseous hydrocarbon feedstock because it has a passive film of chromium oxide on its surface. Therefore, pre-treatment of SS is necessary in order to breach its outer protection layer. Typically, acid etching [26], extensive heat treatment (usually longer than 30 minutes) [14,27], calcination [19], plasma treatment [23], laser treatment [14], or a combination thereof needs to be applied to a SS substrate before CNT growth commences thereon. While in some cases pre-treatment may not be required [28], efficient growth of CNTs demands substrate processing steps. For example, without any pretreatment type 316L stainless steel, unlike 304 SS, shows very limited reactivity to gaseous carbon growth agents [28]. The main difference in composition between 304 SS and 316 SS is that, whereas the former steel does not contain molybdenum (Mo), the latter does contain Mo (at about <2-3%). The presence of molybdenum in 316 SS, in contrast to its absence in 304 SS, enhances the former steel's resistance to chemical attack by corrosion and oxidation.

The presence of molybdenum in 316 SS may be responsible for its reduced reactivity for CNT growth. Whereas molybdenum has been reported to exhibit catalytic activity for CNT growth, [29,30] such enhancements in catalytic activity have been reported only in the case where molybdenum was present together with cobalt (Co). Alvarez et al. reported that there is a synergistic effect between Co and Mo in the production of CNTs [30]. When both metals are simultaneously present, particularly when Mo is in excess, the catalyst is very effective. However, when they are separated they are either inactive (Mo alone) or unselective (Co alone) [30]. In a recent study, Hordy and co-workers reported direct growth of CNTs from 316 stainless steels without any pretreatment [31]; however, since the SS was held within the reactor during their furnace heat up (from room temperature to 700° C.), an undetermined amount of heat treatment was applied in that study.

Van der Wal and Hall [14] suggested that upon the aforementioned surface treatments, fresh metal (particularly iron and nickel) underneath the chromium oxide layer becomes exposed to the environment, and serves as catalyst for CNT growth. Since most such treatments are conducted for long periods of time, at elevated temperatures, and under oxidative conditions, metal grain particles grow to large sizes under these conditions. An ensuing treatment, typically passage through a hydrogen-containing gas at high temperature [14,20] is considered necessary to not only reduce the metal oxides to active metal catalysts but, also to break the formed large grain particles and to create finer catalyst seeds facilitating the synthesis of CNTs. Consequently, CNT growth on stainless steel substrates largely depends on both the substrate surface morphology and on the substrate surface chemical composition; both of these factors affect the surface reactivity.

It is known that increased surface reactivity of stainless steel renders its surface resistant to oxidation or corrosion upon contact with oxidizing or corrosive environments. It has been reported that thick passive layers and smooth surface features reduce the reactivity of such surfaces [32,33]. Studies by Cho and co-workers have concluded that high oxygen pressures lead to rough surfaces with distinct grains [34], and that oxidation temperature and oxygen partial pressure are competing factors on the volumetric diffusion of chromium and the supply of oxygen [35]. They further revealed that a metastable oxide layer forms, containing significant amount of metallic chromium as well as excessive concentration of oxygen on top of the Cr₂O₃ layer at the initial stage of oxidation [36].

There remains a need to develop a fast and efficient process for activating highly corrosion resistant SS, such as SS 316, and rendering it suitable as a catalyst for the synthesis of carbon nanomaterials such as CNTs.

### SUMMARY OF THE INVENTION

The invention provides methods for activating the surface of steel alloys, including highly-corrosion resistant stainless steel (SS) alloys, using brief oxidative heat treatment, to produce catalytic substrates for the synthesis of carbon nanomaterials, such as multi-walled carbon nanotubes (MW-CNTs), by chemical vapor deposition. SS substrates in a variety of forms including fine wire screens (meshes), can be used as both substrate and catalyst to generate MW-CNTs in a reducing environment. Typical additional pretreatment steps, such as etching and reduction of the SS, can be avoided with the methods of the invention. Upon high temperature oxidative treatment, the initially smooth and protective chromium oxide coating layer of the SS was destroyed, and the catalyst surface roughness progressively increased to a maximum with the duration of the treatment. Upon exposure of the pre-treated SS substrates to pyrolyzed hydrocarbon gases in nitrogen, CNTs were readily formed, and their diameters were found to decrease to a minimum with increasing substrate surface roughness. Where the catalyst substrate was pretreated for intermediate duration (e.g., 10 min at 800° C. in air), CNT forests grew vertically, along planes perpendicular to the substrate surface. In all other cases CNTs grew in all directions.

One aspect of the invention is a method of preparing a catalyst for the synthesis of carbon nanomaterials. The method includes the steps of: (a) providing a steel alloy substrate material containing one or more transition metals and an oxidation barrier coating; and (b) heating the substrate material in an oxidizing environment to provide the catalyst. The oxidation barrier coating is at least partially broken down so as to expose the one or more transition metals, which are capable of catalyzing the synthesis of a carbon nanomaterial on a surface of the substrate.

In an embodiment of the method, the steel alloy substrate material is a stainless steel, preferably a highly corrosion resistant stainless steel such as AISI 316 stainless steel. In an embodiment, the stainless steel contains the elements C, Si, Mn, P, S, Ni, Cr, Mo, and Fe. In certain embodiments, the stainless steel further contains the elements Cu and N. In an embodiment, the stainless steel contains at least about 10.5 wt % of Cr. In an embodiment, the oxidation barrier coating contains chromium oxide.

In an embodiment of the method, the step of heating is carried out at a temperature in the range from about 600° C. to about 1000° C. for a time in the range from about 10 seconds to about 30 minutes. In certain embodiments, the step of heating is carried out at a temperature in the range from about 700° C. to about 900° C. In certain embodiments, the step of heating is carried out at about 800° C. for about 1 minute. In other embodiments, the step of heating is carried out at about 1000° C. for a time in the range from about 10 seconds to 1 minute. In an embodiment of the method, wherein the oxidizing environment is air, or contains air. In certain embodiments, the oxidizing environment is a gaseous environment comprising one or more of O₂, O₃, and a mixture of CO₂ and water vapor.

In an embodiment of the method, the step of heating increases surface roughness of a surface of the steel alloy substrate material. In certain embodiments, the rms surface roughness increases to a value in the range from about 25 nm to about 33 nm. In an embodiment, the step of heating increases the mass concentration of oxygen at the substrate surface. In certain embodiments, the mass concentration of oxygen increases to about 1%, or higher than 1%.

In an embodiment of the method, the steel alloy substrate material has a form, at least in part, of a block, wire, cloth, tubing, plate, or wire mesh.

In an embodiment of the method, the method does not include a step such as the use of heat treatment for longer than 30 minutes, plasma treatment, laser treatment, acid etching, or calcination.

In an embodiment of the method, the method further includes the step of cleaning a surface of the steel alloy substrate material prior to heat treatment.

In an embodiment of the method, the method further includes, after the step of heating, the step of storing the catalyst material in an oxygen-free environment. In certain embodiments, the oxygen-free environment contains nitrogen gas or argon gas.

In an embodiment of the method, the method produces a catalyst that is suitable for catalyzing the synthesis of multi-walled carbon nanotubes as the carbon nanomaterial. In certain embodiments, the carbon nanotubes are synthesized as vertically aligned arrays. In certain embodiments of the method, one or more of the time of heat treatment, temperature of heat treatment, and the catalyst surface roughness are selected or adjusted so as to produce carbon nanotubes of a desired diameter.

Another aspect of the invention is a method of synthesizing a carbon nanomaterial. The method includes exposing a catalyst produced by the method described above to a hydrocarbon feedstock, whereby a carbon nanomaterial is synthesized. In some embodiments of the method, wherein the catalyst is exposed to a pyrolytically gasified hydrocarbon polymer at a temperature of about 800° C. In some embodiments of the method, the method results in the production of multi-walled carbon nanotubes.

Yet another aspect of the invention is a catalyst for synthesis of a carbon nanomaterial. The catalyst is made by the method described above, and contains a steel alloy, such as a stainless steel, that has been heat treated in an oxidative atmosphere at a temperature and duration that breaks down the protective chromium oxide layer of the steel, increases surface roughness, and promotes the synthesis of a carbon nanomaterial by a chemical vapor deposition method.

### BRIEF DESCRIPTION OF THE DRAWINGS

FIG. 1 shows a Type 316L (AISI standard) stainless steel mesh substrate (left hand side of the figure) prior to heat treatment and growth of CNTs, and a similar mesh after heat treatment for 10 min. in air and 1 minute of CNT synthesis by chemical vapor deposition (right hand side).

FIGS. 2a-2f show the surface structure by scanning electron microscopy (SEM) of a Type 316L SS substrate after the indicated times of heat treatment (2a, 0 min; 2b, 1 min; 2c, 5 min; 2d, 10 min; 2e, 20 min; and 2f, 90 min) at 800° C. in air. The scale bar represents 400 nm.

FIGS. 3a-3f show atomic force micrographs (AFMs) of a 316 SS substrate surface after the indicated times of heat treatment (3a, 0 min; 3b, 1 min; 3c, 5 min; 3d, 10 min; 3e, 20 min; and 3f, 90 min) at 800° C. in air. The areas shown are each 5 μm×5 μm.

FIG. 4 shows the results of cyclic voltammograms performed using heat treated 316 SS meshes.

FIGS. 5a-5d show the growth of CNTs on heat-treated 316 SS mesh substrates after various times of heat treatment at 800° C. in air (5a, 1 min; 5b, 5 min; 5c, 10 min; and 5d, 20 min). CNTs were visualized by SEM and is shown on the left side of each figure. The distribution of CNT diameter is depicted on the right side of each figure.

FIGS. 6a-6c show the effect of heat treatment duration at 800° C. in air on rms roughness of the 316 SS substrate (FIG. 6a), the mean CNT diameter (FIG. 6b), and the mean CNT yield (FIG. 6c).

FIGS. 7-1a through 7-1c show SEM images of CNT synthesized on 316 SS mesh heat treated for 10 min at 800° C. in air, with CNT synthesis from pyrolyzed polyethylene. The CNTs are vertically aligned and shown at increasing magnification in rows a, b, and c. FIGS. 7-2a through 7-2c show similar CNTs synthesized using pyrolized polystyrene.

FIGS. 8a and 8b show transmission electron micrographs (TEMs) of CNT synthesized using a catalyst according to the invention.

FIG. 9 shows a thermogravimetric analysis (TGA) plot of CNTs synthesized using a catalyst according to the invention.

FIG. 10 shows a Raman spectrum of CNTs synthesized using a catalyst according to the invention (1 min pre-treatment at 800° C. in air).

FIGS. 11a and 11b show SEMs of 316 SS substrates subjected for treatment for 0 min (FIG. 11a) or 90 min (FIG. 11b) at 800° C. in air and following attempted synthesis of CNT. No CNT were formed on either substrate.

FIG. 12 is a schematic diagram of the orientations of CNTs grown on a flat substrate (left side of the figure) and a wire of a mesh substrate (right side of the figure).

### DETAILED DESCRIPTION OF THE INVENTION

The invention provides rapid and cost effective methods for preparing catalysts for the synthesis by chemical vapor deposition of carbon nanomaterials, including carbon nanotubes (CNTs), particularly multi-walled carbon nanotubes (MW-CNTs). The inventors have demonstrated that brief heat pre-treatments of steel alloys, including stainless steels (SS) such as 316L SS, under oxidizing environments such as air are sufficient to produce catalysts capable of supporting growth of carbon nanomaterials directly on their surfaces without the need of additional catalysts. Surface morphology tests, surface elemental analysis, and electrochemistry tests were utilized to characterize the relationship between heat pre-treatment time and subsequent CNT synthesis through changes in surface reactivity.

Without any oxidative heat pretreatment of a steel alloy, such as a stainless steel, no CNTs are formed when using the steel alloy as a catalyst for CNT formation by CVD using pyrolyzed hydrocarbon feedstock. According to the present invention, however, a brief heat treatment in an oxidative atmosphere renders the entire surface of a steel alloy, such as a stainless steel, activated for the synthesis of CNTs. The oxidative heat treatment is believed to act by breaking down a protective chromium oxide coating layer at the steel surface and exposing the metal underneath. Moreover, the inventors have demonstrated for the first time that subsequent reduction of a stainless steel, such as 316L SS, is not necessary in order to achieve efficient CNT growth by CVD synthesis. By comparison, previous methods of activating steel catalysts require lengthy treatments under reducing atmospheres, in addition to lengthy treatments under oxidizing atmospheres [44].

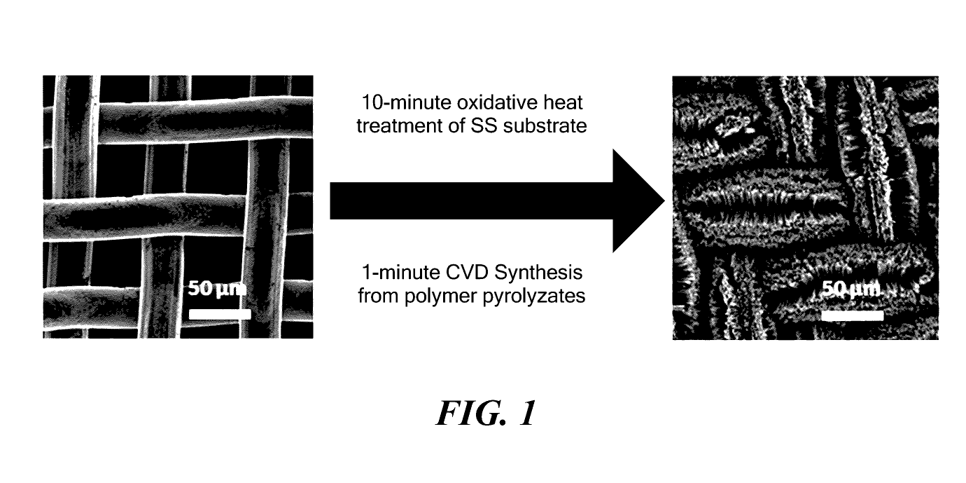

FIG. 1 presents a schematic representation of an embodiment of a method according to the invention. A stainless steel mesh substrate (left hand side of the figure), such as a mesh made of Type 316L (AISI standard) stainless steel, is activated by subjecting it to brief (e.g., 10 min) heat treatment at high temperature (e.g., 800° C.) in an oxidizing environment (e.g., air) prior to the growth of CNTs by CVD. On the right side of the figure is a similar mesh after the activation process and 1 minute of CNT synthesis by chemical vapor deposition. The activation protocol replaces the much lengthier and more complex activation process previously known for such stainless steel substrates, which involved plasma or laser etching, long treatments (e.g., 60-90 min) in oxidizing and/or reducing environments, or calcination.

A catalyst according to the present invention is a steel alloy substrate that is capable of accelerating the rate of synthesis of a carbon nanomaterial by a chemical vapor deposition (CVD) method. The catalyst can have any physical form, shape, or size, as required for the desired application. Preferred forms include a sheet or plate, block (solid or hollow), wire, woven cloth, tubing or pipe, or wire mesh, or another shape. Wire mesh is a preferred form because it provides a high surface area for carbon nanomaterial formation. Carbon nanomaterials include various graphene-based structures containing, consisting of, or consisting essentially of carbon atoms, such as multi-walled carbon nanotubes (MW-CNTs), single-walled carbon nanotubes, or graphene sheet. Preferred carbon nanomaterials are MW-CNTs. The catalyst may serve as a substrate for the synthesis of carbon nanomaterials on its surface, which remain attached after synthesis, or become detached, or can be detached by a process such as sonication in a suitable solvent, such as an alcohol, water, or an aqueous solution.

Any steel alloy possessing a protective barrier coating can be used to make the catalyst. The protective barrier coating can be an oxidation barrier, including chromium oxide, covering a core portion of the steel substrate possessing one or more transition metals. The transition metals are suitable for catalyzing carbon nanomaterial formation by CVD. Any transition metal can be utilized for this purpose, but preferably one or more transition metals such as Co, Ni, Fe, or Mb are present. Preferably the steel alloy contains C, Si, Mn, P, S, Ni, Cr, Mo, and Fe, and may also contain Cu and N. Especially preferred are stainless steels containing at least 10.5 wt % of Cr and containing Mb. Stainless steels having an austenitic structure are preferred. Most preferred is AISI type 316 stainless steel (containing 16-18.5% Cr, 10-14% Ni, 2-3% Mo, <2% Mn, <1% Si, <0.045% P, <0.03% S, <0.03% C, balance Fe), which has especially good corrosion resistance. In certain embodiments, the steel alloy does not include type 304 stainless steel.

The method requires heating the steel alloy substrate to a high temperature for a short period of time. The purpose of the heat treatment is to at least partially break down or compromise the protective oxidation barrier coating and also to increase surface roughness. As described below, heat treatment that is at too low or too high a temperature, or is for too short or too long duration, will not produce an active catalyst, or will not result in optimal activation of the catalyst. Appropriate temperatures must be combined with appropriate duration of heat treatment and degree of oxidation effectiveness of the environment during heat treatment. For example, suitable treatments include use of a temperature range from about 600° C. to about 1000° C. for a time in the range from about 10 seconds to about 30 minutes. Alternative suitable conditions include temperature from about 700° C. to about 900° C., or about 800° C., or about 1000° C. As the temperature is increased, the duration of treatment should be shortened. For example, treatment at 800° C. can be for about 1 minute or somewhat longer, whereas treatment at 1000° C. can be selected at about 10 seconds to about 1 minute. Treatment at 700° C. for 1 minute to 30 minutes is suitable, as is treatment at 800° C. for 1 minute to about 26 minutes. Treatment at 1200° C. can be performed for up to about 12 minutes. Times less than 10 seconds or longer than 30 minutes generally result in poor or no catalyst activity.

The process of catalyst activation can be optimized by varying the following parameters until suitable conditions are obtained: heat treatment temperature, heat treatment duration, composition of oxidizing atmosphere, surface roughness obtained (e.g., rms surface roughness), chemical composition of surface material (e.g., oxygen enrichment), substrate morphology, and chemical composition of the steel alloy.

Air provides a suitable oxidizing environment, but air may be replaced by or combined with, for example, O₂, O₃, or a mixture of CO₂ and water vapor, or other oxidizing atmospheres. However, following activation the catalyst should be stored in an oxygen-free environment if it is to remain stable for later use (e.g., up to two months or longer), such as by storage in nitrogen or argon gas, Preferably, the activated catalyst is used for carbon nanomaterial synthesis by CVD soon after catalyst activation, e.g., within minutes, hours, or a few days of activation.

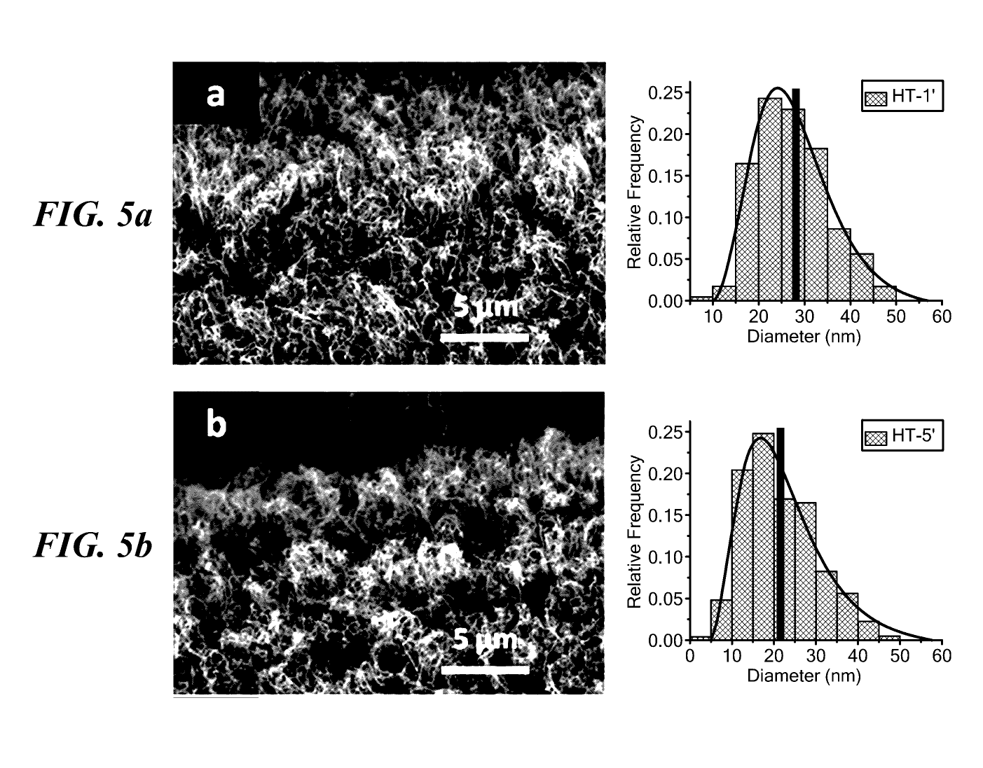

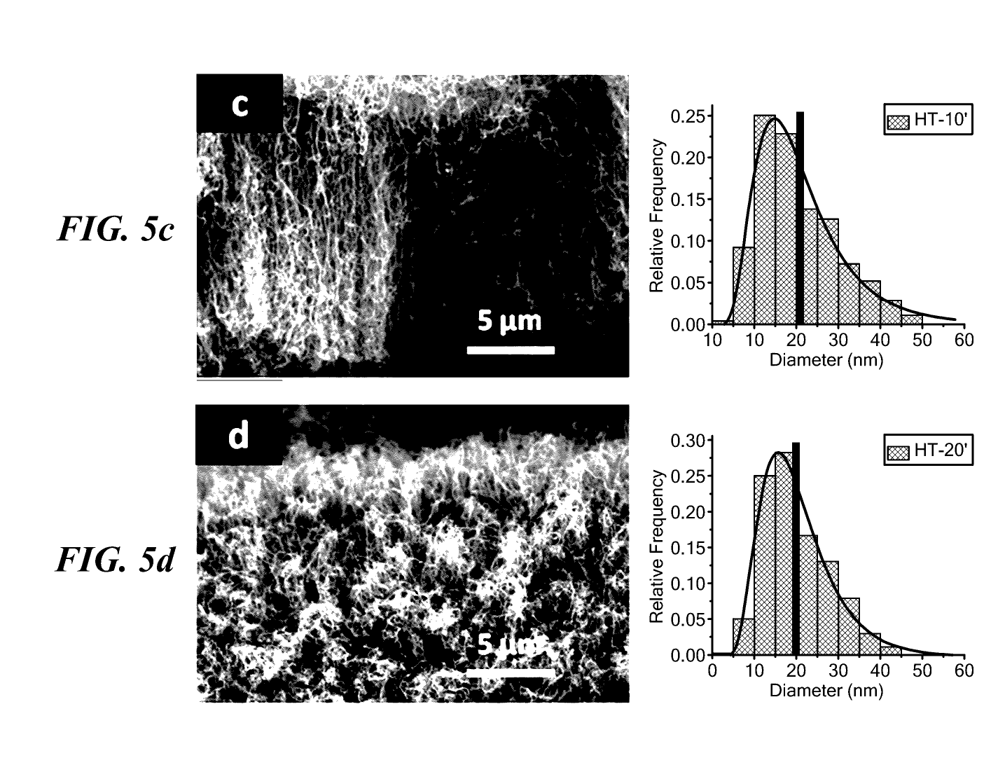

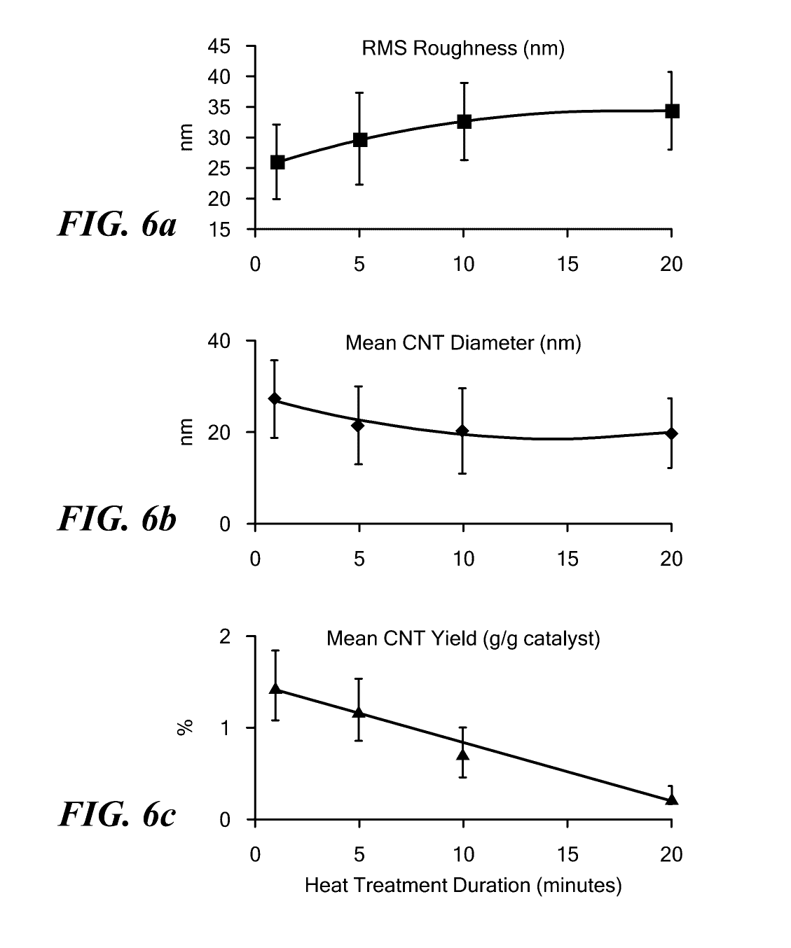

The present invention has shown that the heat treatment of SS and its effects on CNT growth are tunable by simply varying the duration of heat treatment. The resulting yield of CNT synthesis as well as the dimensions of the resulting CNT products can be readily controlled. For example, using the catalytic substrates formed by heat pre-treatment of 316 SS wire meshes for 1, 5, 10, and 20 minutes, the mean diameters of the synthesized CNTs were 27±8.5, 22±8.5, 20±9.3, and 20±7.6 nm, respectively (see Example 3, FIGS. 5a-5d and 6b, and Table 4). Statistics suggested that the diameter variations closely fit a log-normal distribution, consistent with there being several independent variables affecting CNT diameter (see also reference [45]). One way analysis of variance (ANOVA) indicated that heat treatment does affect surface roughness, CNT diameter, and CNT yields.

Surprisingly, in the present invention, the vertical and substantially parallel aligned growth of CNT could only be achieved with moderate pretreatment times, but not with shorter or longer times. As shown in FIGS. 5a-5d, when CNTs were grown on SS substrates treated for 1 minute, there was no evidence of vertical growth, even though the highest yields were achieved at this brief pre-treatment time. Vertical growth is usually considered as the result of a crowding effect [53]. Therefore, the vertical growth of CNTs is believed to result from the combined effects of catalyst roughness and particle size, and consequentially nanotube diameters. Vertically aligned CNT forests made by the present method can be used, for example, for filtration or as emitters of electromagnetic radiation (field emission displays). Other uses of CNTs produced by a method of the invention (aligned or non-aligned) include in automotive tires, flame retardants, waterproofing, electric motor brushes, electromagnetic antennas, electrodes, batteries, supercapacitors, enhancers of thermal radiation, stealth technology, and loudspeaker materials.

The present invention achieves simultaneous reduction of substrate surface oxides and efficient CNT growth in part because the polymer pyrolyzates used as feedstocks contain large amounts of hydrocarbons and hydrogen. Further, because the costs associated with both etching and extra reduction treatments of the catalyst substrate are eliminated, the present pre-treatment method is expected to provide substantial cost savings during scale-up and commercial production.

### EXAMPLES

### Example 1

### Catalyst Formation by Heat Treatment of Stainless Steel

Scanning electron microscopy (SEM) was performed using a Hitachi S-4800 electron microscope equipped with energy dispersive spectroscopy (EDS). SEM was used to reveal the surface morphology and elemental composition of the substrates, as well as of the synthesized CNTs. An accelerating voltage of 3 kV, a beam current of 10 μA, and a working distance of 8.2 mm were applied for SEM imaging, whereas an accelerating voltage of 30 kV, a beam current of 10 μA and a working distance of 15 mm were applied for EDS analysis.

Atomic force microscopy (AFM) was conducted using an Agilent 5500 instrument to investigate the substrate surface roughness down to the nanometer scale. AFM scanning was performed on the SS samples after oxidative heat treatment for 1, 5, 10, or 20 minutes. An untreated steel sample was also investigated as a control. The samples were cut into 1 cm by 1 cm small pieces and were immobilized on glass cover slips using double-sided tape. Thin film topography was obtained by contact mode scanning, using a regular AFM cantilever (CONTV-A, Bruker, Inc.). Scanning velocity was set at 1 line/second with resolution of 256 lines/frame. A typical topography was first identified with a low resolution scanning mode and, subsequently, 5 μm high-resolution scanning was implemented, upon repositioning the AFM tip over various segments of the sample. At least six different spots were examined using the AFM contact mode scanning for each sample, and at least five different topographies were used to calculate the surface roughness of each image.

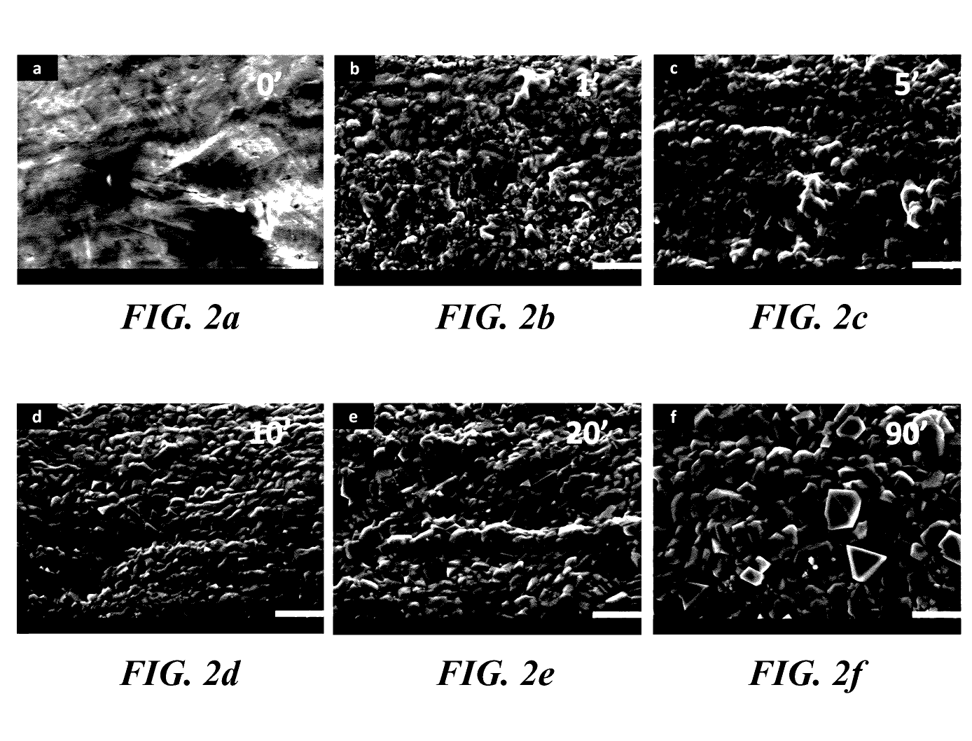

The passivation layer of chromium oxide (Cr₂O₃), formed upon exposure of stainless steels to oxygen, imparted a smooth surface in SEM images (see FIG. 2a). Type 316 SS was used in these experiments. In contrast to this rather smooth surface of the untreated substrate (with its inherent grain boundaries), particle islands appeared upon heat treatment for 1 minute (see FIG. 2b). In the FIG. 2b sample, the top surface layer formed cracks. Two types of surface morphology were evident following heat treatment, one with individual surface extrusions, and the other with bumps of larger coverage. However, although dome-like structures emerged as the treatment time increased to 20 minutes, each structure was rather smooth and without clear borders. By contrast, individual surface extrusions with sharp edges and sizes around 200 nm were evident after prolonged heat treatments of 90 minutes (see FIG. 2f).

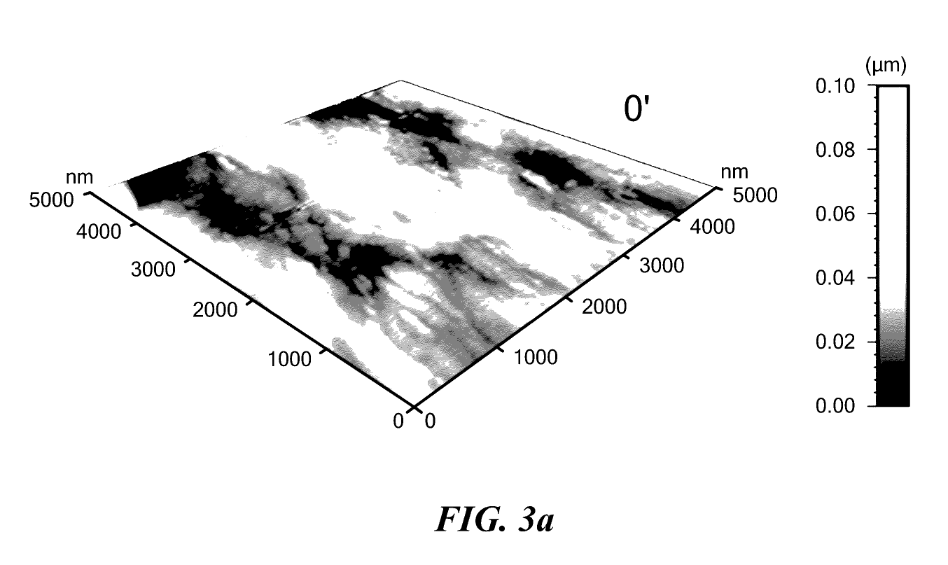

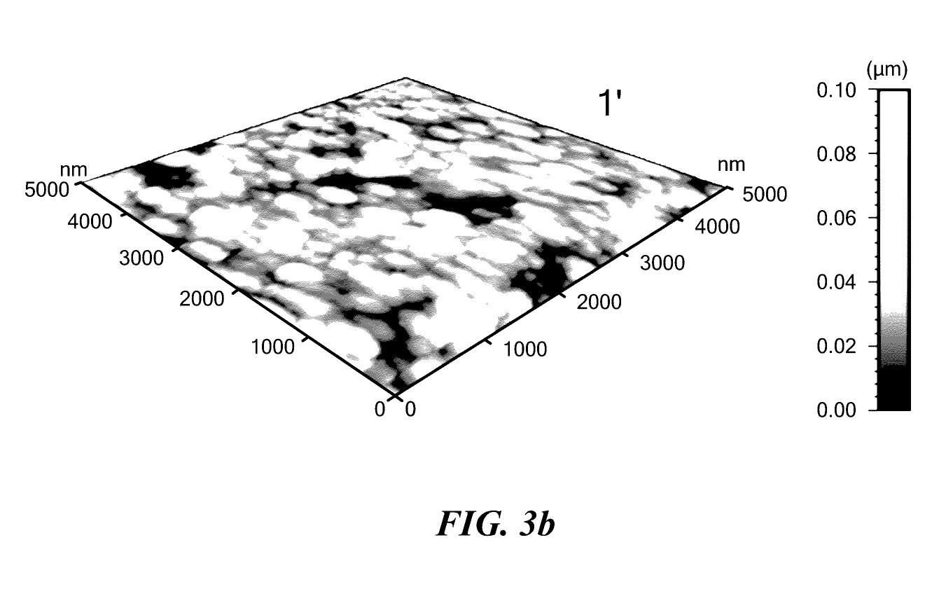

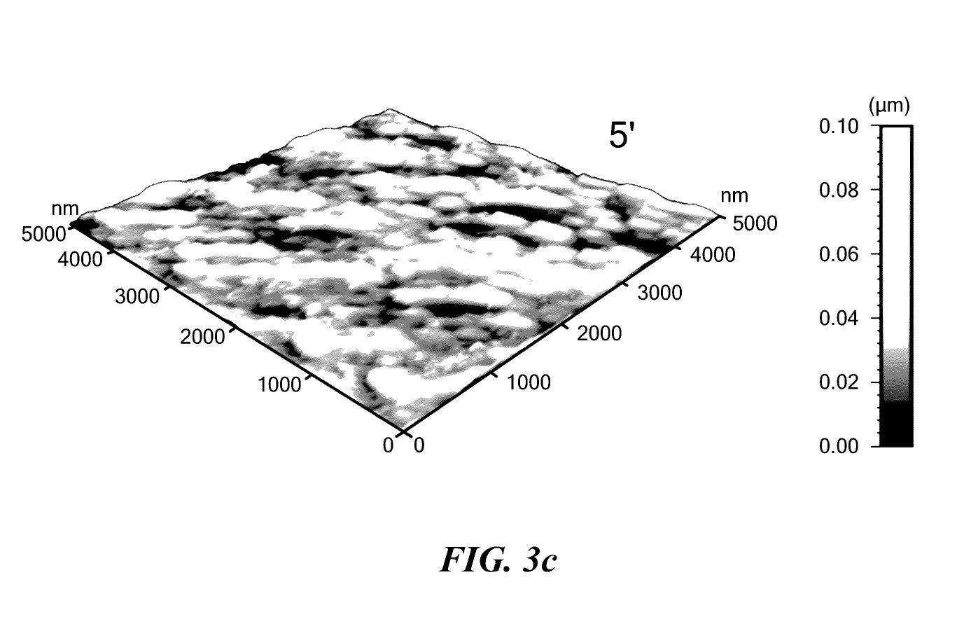

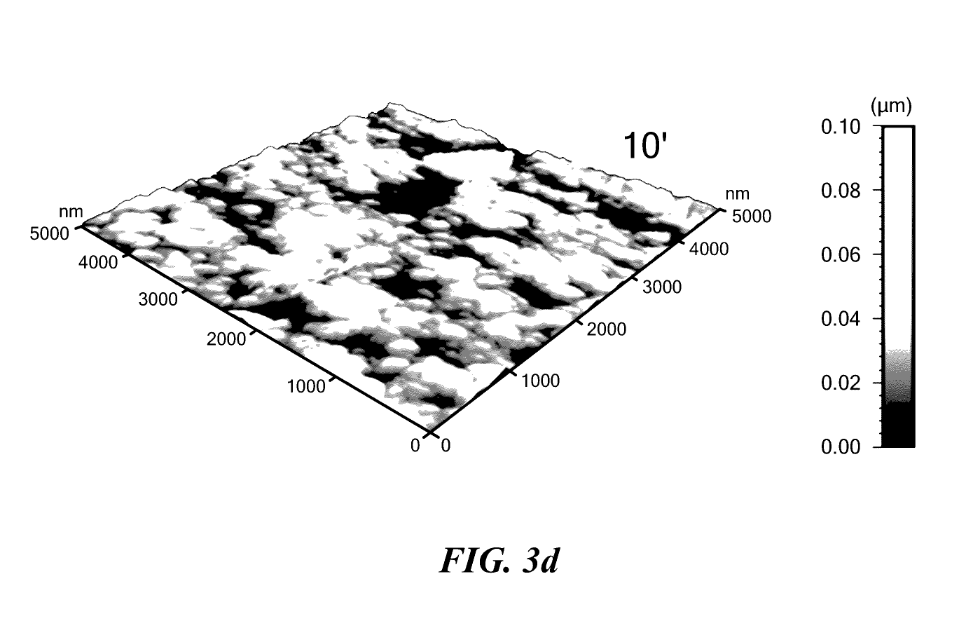

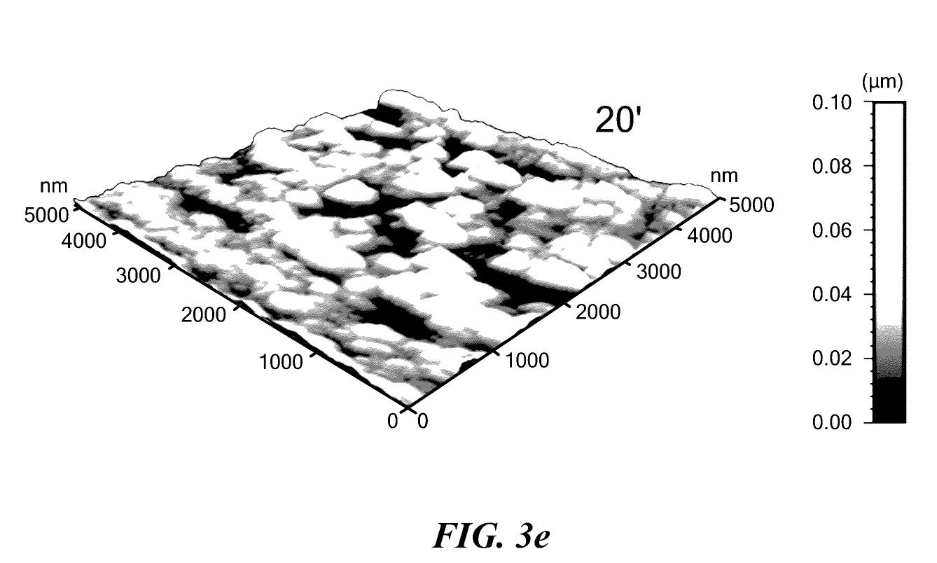

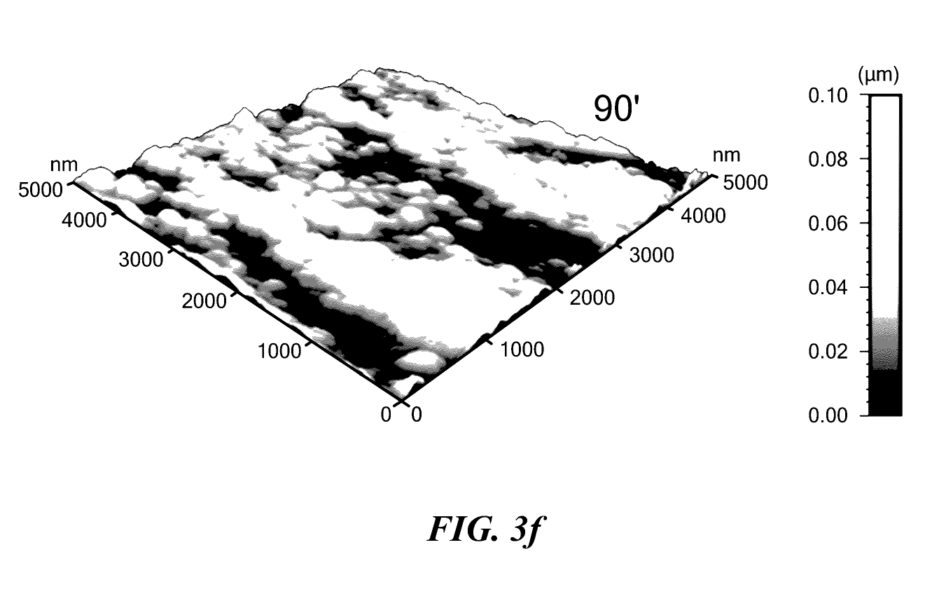

Further characterization using AFM revealed the effects of the heat treatment quantitatively. Representative AFM images (shown in FIGS. 3a-3f) illustrate similar trends in substrate surface development as seen in SEM images. Further analysis using line scanning data (not shown) enabled the calculation of root mean square (rms) roughness for each sample, through the following equation (reference [37]):

$${R}_{q} = \sqrt{\frac{1}{L} {\int }_{0}^{L} {( Z ( x ) - {Z}_{0} )}^{2} d x}$$

Z is the surface topography along the scan line, Zₒ is the averaged surface topography, and L is the total scanning length. Calculated results are listed in Table 1, and show that the RMS roughness started from 15±4 nm for the surface without oxidative heat treatment, and increased to 44±6 nm for the surface with 90 min oxidative heat treatment.

TABLE 1
Surface RMS roughness for 316 L stainless steels with
different heat treatment duration.

| Treatment | RMS | RMS Roughness |
|---|---|---|
| Time | Roughness | STD |
| (min) | (nm) | (nm) |
| 0′ | 15 | 4 |
| 1′ | 26 | 6 |
| 5′ | 30 | 7 |
| 10′ | 33 | 6 |
| 20′ | 34 | 6 |
| 90′ | 43 | 6 |

In addition to the examination of the evolution of surface morphology with oxidative heat treatment duration, the surface chemical composition was also assessed by EDS analysis. As listed in Table 2, the major elements in the 316L stainless steel sample surface were thus determined. The mass concentration of Mo, Cr, Mn, Fe, Ni were in line with the 316L SS initial composition, and did not exhibit obvious changes upon heat treatment. The mass concentration of oxygen, however, showed a significant increase from 0.64±0.02% at no heat treatment to 1.03±0.03% with a 1 minute heat treatment, and to 1.35±0.05% after 20 minutes of heat treatment. Such increases are attributable to surface oxidation at high temperature in an oxidative atmosphere.

TABLE 2
Surface composition (by wt. %) of SS substrate before and after heat treatment.

| Oxidative Heat | | | | | | |
|---|---|---|---|---|---|---|
| Treatment | | | | | | |
| (min) | O (%) | Mo (%) | Cr (%) | Mn (%) | Fe (%) | Ni (%) |
| 0′ | 0.64 ± 0.02 | 1.67 ± 0.04 | 16.91 ± 0.05 | 1.59 ± 0.05 | 69.28 ± 0.09 | 9.91 ± 0.08 |
| 1′ | 1.03 ± 0.03 | 1.70 ± 0.04 | 17.03 ± 0.08 | 1.60 ± 0.08 | 69.19 ± 0.25 | 9.44 ± 0.20 |
| 5′ | 1.10 ± 0.03 | 1.83 ± 0.02 | 16.93 ± 0.12 | 1.49 ± 0.12 | 69.04 ± 0.35 | 9.60 ± 0.24 |
| 10′ | 1.25 ± 0.02 | 1.78 ± 0.04 | 16.85 ± 0.12 | 1.69 ± 0.08 | 68.68 ± 0.21 | 9.76 ± 0.18 |
| 20′ | 1.35 ± 0.05 | 1.63 ± 0.04 | 16.90 ± 0.13 | 1.55 ± 0.07 | 68.94 ± 0.18 | 9.65 ± 0.24 |

### Example 2

### Effect of Heat Treatment on Surface Reactivity

An Autolab PGSTAT 30 potentiostat (Metrohm USA, formerly Brinkman Instruments) was used for cyclic voltammetry measurements in a 3.56% (by weight) sodium chloride solution, made by dissolving 34 g of reagent grade NaCl in 920 mL of distilled water. After different oxidative heat treatments, SS samples with dimensions of 8 mm×6.25 mm were exposed to the NaCl solution. Voltammetry was carried out at room temperature in a three-electrode cell. All potentials were measured with respect to a Ag/AgCl reference electrode (212 mV vs. SHE), and anodic currents are shown as positive. All the measurements were collected after stable open circuit potentials (Eocp) of the electrodes in the solution were achieved.

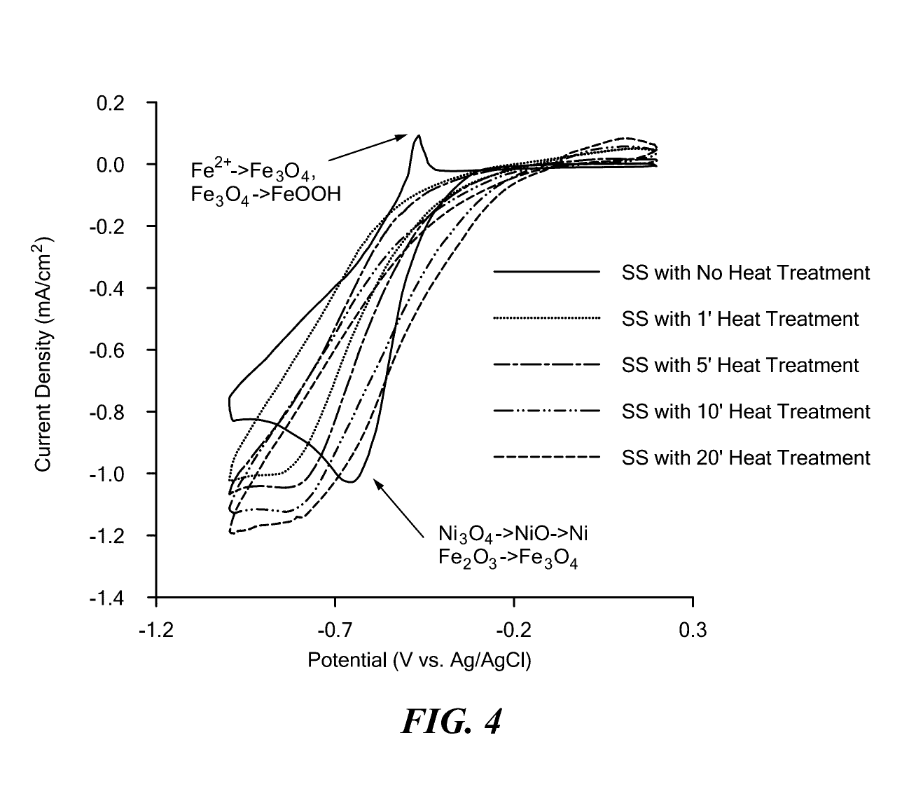

Potentiodynamic measurements showed that the cyclic voltammograms of all the heat treated SS meshes had similar shapes (FIG. 4), but all were distinguishable from cyclic voltammograms of the untreated SS mesh. Specifically, a peak associated with reversible partial oxidation of iron oxide (−0.46 V vs. Ag/AgCl; see reference [38]) was only present in the case of the stainless steel surface without oxidative heat treatment. See FIG. 4. The disappearance of the reversible partial oxidation peak confirmed that a higher oxidation state of iron was reached on the SS surface upon high temperature oxidation. Further, the peak associated with reversible partial reduction of nickel oxide moved from −0.69 V vs. Ag/AgCl to −0.81 V vs. Ag/AgCl after heat treatment. See FIG. 4.

Table 1 lists the parameters of open circuit potential (Eocp), pitting potential (Epit), and passive region which were obtained from the voltammograms. Open circuit potential, Eocp, describes the potential of a sample relative to the reference electrode when no voltage or current is being applied. Pitting potential, Epit, signifies a potential threshold above which pitting (a localized reaction) grows but below which pitting ceases to occur (see reference [39]). Smaller Epit (−0.43<−0.27) indicates lower oxidation/corrosion resistance (see reference [40]). A larger passive region, ΔE=Eocp−Epit, indicates either thicker passive layers, or greater resistance to pitting (see reference [41]).

The experimental data listed in Table 3 suggest that longer oxidative thermal treatments of SS substrates thicken the passive layer, as indicated by a larger measured passive region (ΔE), and increase oxidation/corrosion resistance, thus decreasing the SS surface reactivity. This is consistent with the trend in CNT yields obtained herein, as described in Example 3 below.

TABLE 3
Potentiostatic measurements of SS substrates with
oxidative heat treatments.

| SS heat | Open Circuit | | |
|---|---|---|---|
| treatment | Potential, E_{ocp} | Pitting Potential, Eₚᵢₜ | Passive Region, ΔE |
| (min) | (V vs. Ag/AgCl) | (V vs. Ag/AgCl) | (V vs. Ag/AgCl) |
| 0′ | 0.01 | −0.436 | 0.446 |
| 1′ | 0.10 | −0.428 | 0.528 |
| 5′ | 0.16 | −0.423 | 0.583 |
| 10′ | 0.27 | −0.322 | 0.592 |
| 20′ | 0.32 | −0.274 | 0.594 |

### Example 3

### Synthesis of Carbon Nanotubes

CNT synthesis experiments were conducted in a two-stage reactor (described in reference [8]), where feedstocks of solid post-consumer polymers (polyethylene, polystyrene, etc.) were pyrolytically gasified to supply gaseous hydrocarbons and hydrogen that are needed for the growth of the CNTs on pre-treated 316L SS mesh substrates/catalysts.

To achieve conversion of solid hydrocarbon fuels to CNTs, quantities of a solid feedstock, either polyethylene or polystyrene in pelletized form was first thermally pyrolyzed into a stream of gaseous decomposition products (pyrolyzates) inside a pyrolyzer furnace at 600˜800° C. Pyrolysis occurred in a nitrogen atmosphere with a flowrate of 1 standard liter per minute (slpm), which prevented the ignition and combustion of the pyrolyzates. The pyrolyzates then entered the second furnace where rolled up catalyst SS substrates were pre-inserted. Growth of CNTs occurred on the catalyst substrates at a furnace temperature of 800° C.

Transmission electron microscopy (using a JEOL 1010 electron microscope) was used with an accelerating voltage of 70 kV and a beam current of 60 μA to examine the structure of the synthesized CNTs, CNTs were removed from SS meshes by sonication in 100% ethanol. When CNTs were identified, their cross-sectional diameters were determined by analysis of SEM or TEM images with ImageJ, an image analysis software program maintained by the NIH. At least 200 individual tubes were measured at each condition. Statistical analysis was performed using Excel®.

Thermo-gravimetric analysis (TGA) was conducted using a Model Q50 by TA Instruments. The heating rate was 20° C. per minute under air flow. The temperature increased from ˜25° C. to 900° C.

Raman spectrometry was conducted using a Jobin Yvon LabRam HR800 system with 488 nm wavelength laser probe, 100× objective, laser spot of ˜1 μm, and signal collection of 60 seconds.

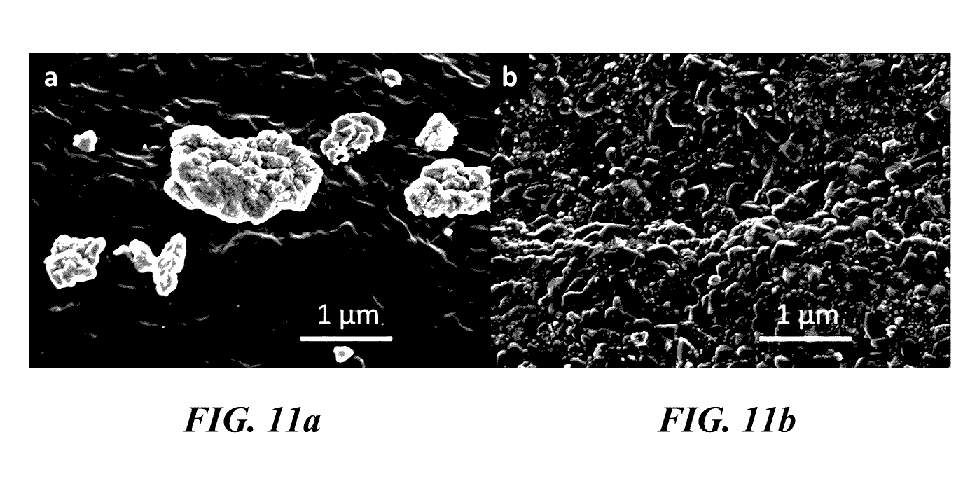

As illustrated in FIG. 6c, the mean yield (defined as the ratio of the mass of synthesized CNTs to that of the catalyst substrate) reached a maximum when SS meshes were heat treated for just 1 minute at 800° C. With longer heat treatments at that temperature, the yield decreased proportionally to the time of heat treatment. There was no evidence of CNT generation when SS meshes were not pre-treated at all (see, e.g., FIG. 11a), or were pre-treated for 90 minutes (FIG. 11b). Chernozatonskii and co-workers [46] have reported that CNT diameter is affected by the catalyst particle grain size, which is further affected by particle mobility, sintering, and re-dispersion processes. Such processes are generally represented by Ostwald ripening [47], which describes phenomena occurring during continued heating of particles at the nanoscale [48]. As Ostwald ripening proceeds, the growth of larger particles and shrinking of smaller particles takes place and, eventually, the latter disappear via atomic inter-diffusion [48-50]. Therefore, the number of catalyst particles decreases while the average catalyst particle diameter increases, as also does the spread in the particle size distribution. The increase in particle size is visible in FIGS. 2a-2f. It is believed that the decrease of CNT generation with substrate treatment duration yield may be due at least in part to a decreasing number of catalyst particles suitable for CNT growth. Table 4 below provides a summary of the changes in surface roughness, CNT diameter, and CNT yield with duration of heat treatment.

TABLE 4
Summary of surface roughness, CNT diameter,
and CNT yield as a function of different heat
pre-treatment duration of the substrate.

| | RMS | RMS | | CNT | Mean | CNT |
|---|---|---|---|---|---|---|
| Treatment | Rough- | Roughness | Mean CNT | diameter | CNT | Yield |
| Time | ness | STD | Diameter | STD | Yield | STD |
| (min) | (nm) | (nm) | nm | nm | % | % |
| 0′ | 15 | 4 | 0 | 0 | 0 | 0 |
| 1′ | 26 | 6 | 27 | 7.7 | 1.45 | 0.37 |
| 5′ | 30 | 7 | 22 | 8.5 | 1.19 | 0.33 |
| 10′ | 33 | 6 | 20 | 9.3 | 0.73 | 0.26 |
| 20′ | 34 | 6 | 20 | 7.6 | 0.26 | 0.09 |

Longer oxidative heat treatment leads not only to larger catalyst particle size, but also to higher degrees of metal oxidation, which could block or poison the CNT synthesis. As indicated by the distribution trends in FIGS. 6a-6b, both the surface roughness (rms roughness) and the CNT diameters exhibited quadratic relations with respect to the substrate oxidative pre-treatment durations (the trendline of the former being y=−0.03x²+1.1x+25, with the coefficient of determination R²=0.9997, and the trendline of latter being y=0.04x²−1.3x+28, with coefficient of determination R²=0.9401, respectively). The mean CNT yields, however, exhibited a linear relation with heat treatment duration (the corresponding trendline being y=−0.06x+1.5, with the coefficient of determination R²=0.9787). Based on the results shown in FIGS. 6a-6b, maximum roughness and minimum diameter (averaged) was achieved at heat treatments in the range of 10 to 20 minutes. Statistical analyses on the results of the parameters shown in FIG. 5 were conducted (a) for the surface roughness of the substrates based on 5 different topographies, (b) for the diameters of the CNTs based on 200 individual tube measurements, and (c) for yields based on three different experiments. Error bars signifying standard deviation (a) are shown in FIGS. 6a-6c.

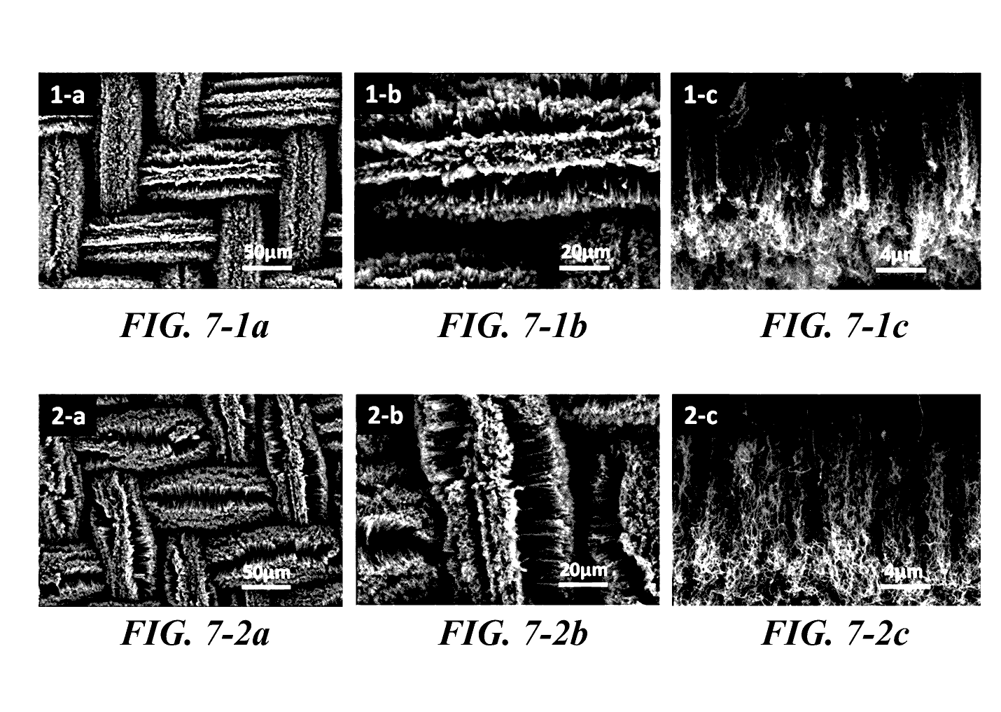

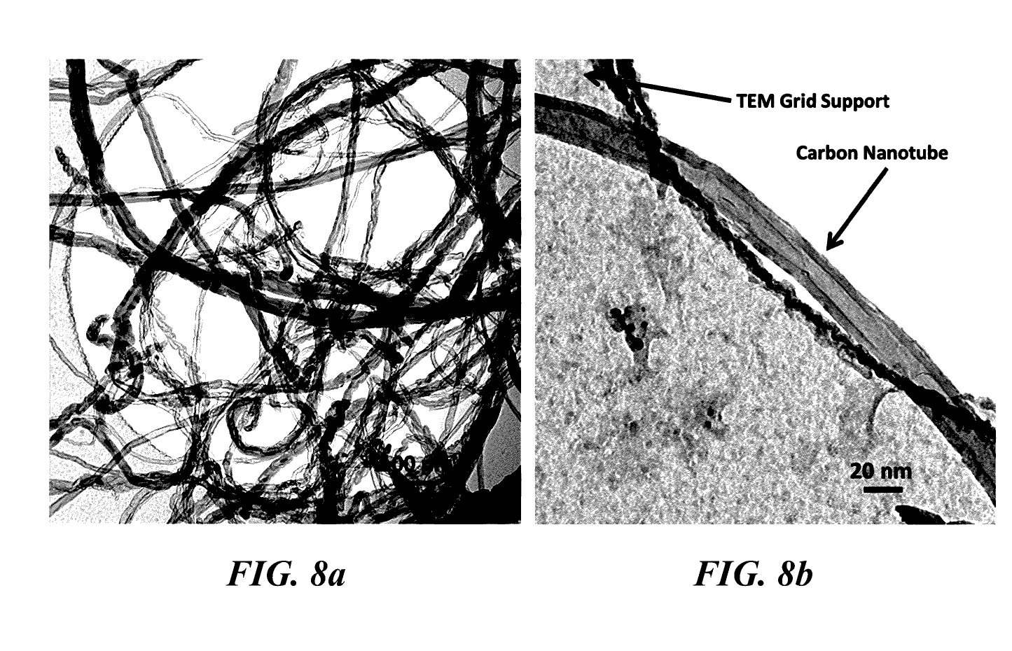

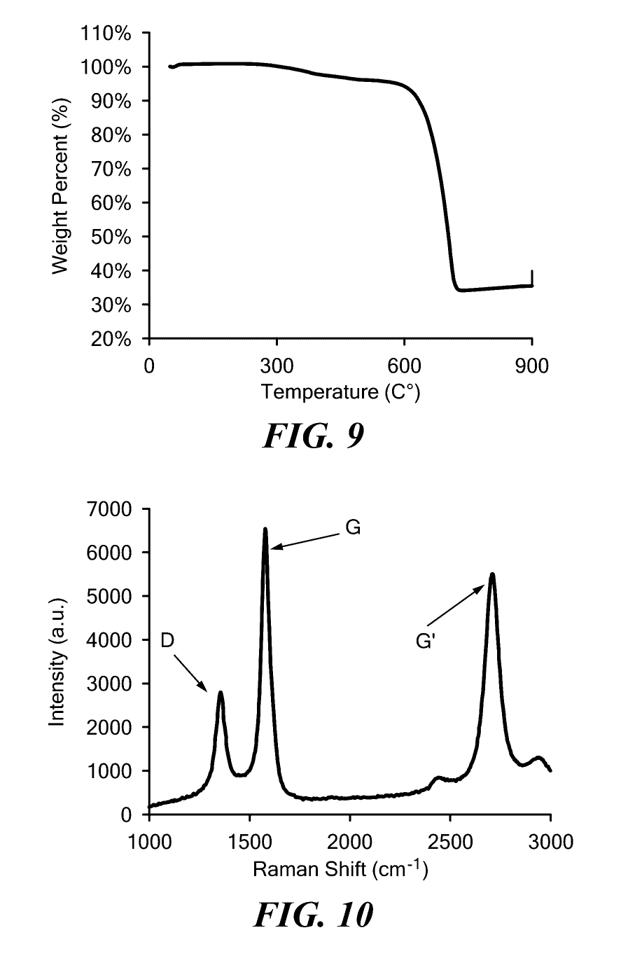

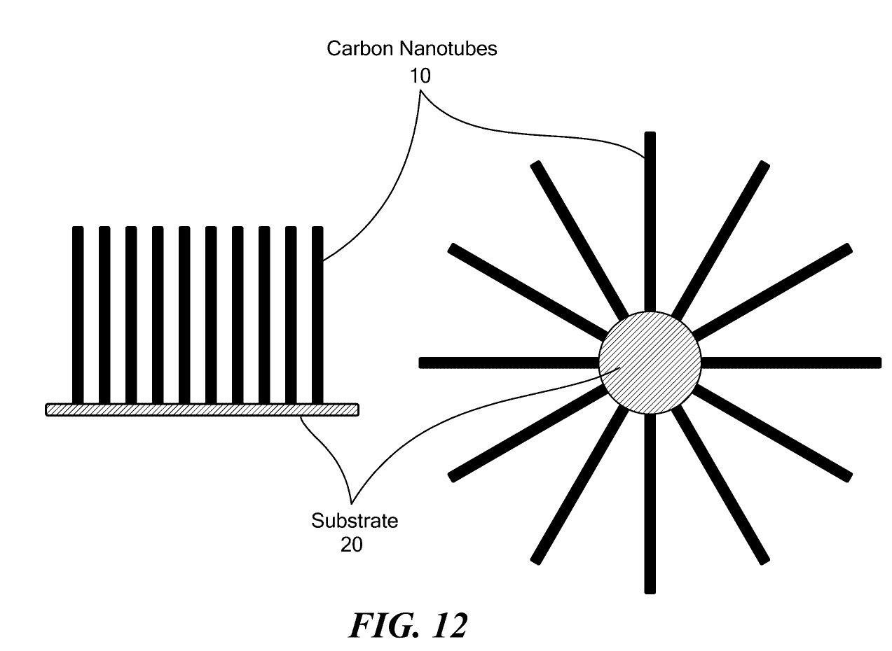

Besides changes in CNT dimensions, varying the duration of heat treatment also affected the architectures of the synthesized CNTs. Under most growth conditions, random CNT clusters are spread over the SS surface. However, in this study, vertically grown CNT forests were unexpectedly generated in planes perpendicular to the wire mesh catalyst surface (i.e., cylindrically distributed around the wire periphery, as illustrated in FIG. 12), when the SS substrates were heat treated for 10 minutes at 800° C. before the carbon bearing gases were introduced to the synthesis reactor. As shown in FIGS. 5c and 7-1a through 7-2c, brush-like CNT arrays were oriented vertically to the SS wire surfaces with a height of ˜20 μm. It appears that the alignment of CNTs followed the striation of the drawing marks on the wires. TEM imaging of the resulting CNTs showed the absence of amorphous carbons (FIGS. 8a-8b). However, the possible presence of non-crystalline carbonaceous materials (such as CNTs with non-graphitized impurities) cannot be excluded, as the corresponding oxidative thermogravimetric analysis (TGA) plot showed a slight decrease of mass around the temperature of 330° C. (FIG. 9). As no complex pretreatments are needed, this result further supports the use of stainless steels as effective catalyst substrates for applications involving CNTs, especially in electronics, where direct electrical contact is usually required between the CNTs and the substrates [53], as well as in filtration, where templates are necessary to provide structural support of the CNTs [24, 25].

When the synthesized CNTs were examined using Raman spectroscopy, the G-band, the D-band, and the G′-band were the three major vibration modes encountered (see FIG. 10). The G-band with its peak at ˜1582 cm⁻¹ is a typical resonance feature of the Raman spectra of graphitic material (sp2 bonded carbon) as a result of stretching of the C—C bond [54]. With its peak at ˜1345 cm⁻¹, the D-band is induced by the presence of sp3-hydribidized carbon. The G′-band, which is also denoted as 2D, has its peak usually found in the range of 2500-2800 cm⁻¹. It is a feature of a second-order two-phonon process [54,55]. In this study, CNTs synthesized on the pre-treated SS mesh surfaces exhibited strong peaks of the G-band (IG/ID=2.28), indicating the presence of graphitic carbon [56]. In addition, there were strong peaks corresponding to the G′-band (IG′/ID=1.9), indicating the presence of parallel graphitic layers.

As used herein, a composition or method that “consists essentially of” certain materials or steps can also include unstated materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

[1] S. Iijima, Helical microtubules of graphitic carbon, Nature, 354 (1991) 56-58.
[2] P. M. Ajayan, S. Iijima, Smallest Carbon Nanotube, Nature, 358 (1992) 23-23.
[3] S. Iijima, T. Ichihashi, Single-shell carbon nanotubes of 1-nm diameter, Nature, 363 (1993) 603-605.
[4] M. M. Oye, S. Yim, A. Fu, K. Schwanfelder, M. Meyyappan, C. V. Nguyen, Surface Smoothness Effect for the Direct Growth of Carbon Nanotubes on Bulk FeCrAl Metal Substrates, Journal of Nanoscience and Nanotechnology, 10 (2010) 4082-4088.
[5] M. F. L. De Voider, S. H. Tawfick, R. H. Baughman, A. J. Hart, Carbon Nanotubes: Present and Future Commercial Applications, Science, 339 (2013) 535-539.
[6] C. Zhuo, B. Hall, H. Richter, Y. Levendis, Synthesis of carbon nanotubes by sequential pyrolysis and combustion of polyethylene, Carbon, 48 (2010) 4024-4034.
[7] C. Zhuo, J. O. Alves, J. A. S. Tenorio, Y. A. Levendis, Synthesis of carbon nanomaterials through up-cycling agricultural and municipal solid wastes, Industrial & Engineering Chemistry Research, 51 (2012) 2922-2930.
[8] C. Zhuo, Y. A. Levendis, Upcycling waste plastics into carbon nanomaterials: A review, Journal of Applied Polymer Science, 131 (2013).
[9] J. Gong, K. Yao, J. Liu, X. Wen, X. Chen, Z. Jiang, E. Mijowska, T. Tang, Catalytic conversion of linear low density polyethylene into carbon nanomaterials under the combined catalysis of Ni2O3 and poly(vinyl chloride), Chem Eng J, 215-216 (2013) 339-347.
[10] J. Gong, J. Liu, Z. Jiang, X. Wen, X. Chen, E. Mijowska, Y. Wang, T. Tang, Effect of the added amount of organically-modified montmorillonite on the catalytic carbonization of polypropylene into cup-stacked carbon nanotubes, Chem Eng J, 225 (2013) 798-808.
[11] J. Gong, J. Liu, Z. Jiang, J. Feng, X. Chen, L. Wang, E. Mijowska, X. Wen, T. Tang, Striking influence of chain structure of polyethylene on the formation of cup-stacked carbon nanotubes/carbon nanofibers under the combined catalysis of CuBr and NiO, Applied Catalysis B: Environmental, 147 (2014) 592-601.
[12] X. Wen, X. Chen, N. Tian, J. Gong, J. Liu, M. H. Rümmeli, P. K. Chu, E. Mijiwska, T. Tang, Nanosized Carbon Black Combined with Ni2O3 as “Universal” Catalysts for Synergistically Catalyzing Carbonization of Polyolefin Wastes to Synthesize Carbon Nanotubes and Application for Supercapacitors, Environmental Science & Technology, 48 (2014) 4048-4055.
[13] J. Gong, J. Feng, J. Liu, Z. Jiang, X. Chen, E. Mijowska, X. Wen, T. Tang, Catalytic carbonization of polypropylene into cup-stacked carbon nanotubes with high performances in adsorption of heavy metallic ions and organic dyes, Chem Eng J, 248 (2014) 27-40.
[14] R. L. Vander Wal, L. J. Hall, Carbon nanotube synthesis upon stainless steel meshes, Carbon, 41 (2003) 659-672.
[15] F. S. Cai, J. Wang, Z. H. Yuan, X. L. Du, Growth of aligned multiwalled carbon nanotube arrays film on stainless steel substrates for electrode applications, J Optoelectron Adv M, 14 (2012) 267-271.
[16] F. Le Normand, C. S. Cojocaru, O. Ersen, P. Legagneux, L. Gangloff, C. Fleaca, R. Alexandrescu, F. Dumitrache, I. Morjan, Aligned carbon nanotubes catalytically grown on iron-based nanoparticles obtained by laser-induced CVD, Applied Surface Science, 254 (2007) 1058-1066.
[17] T. Somanathan, A. Pandurangan, Catalytic activity of Fe, Co and Fe—Co-MCM-41 for the growth of carbon nanotubes by chemical vapour deposition method, Applied Surface Science, 254 (2008) 5643-5647.
[18] J. K. Radhakrishnan, P. S. Pandian, V. C. Padaki, H. Bhusan, K. U. B. Rao, J. Xie, J. K. Abraham, V. K. Varadan, Growth of multiwalled carbon nanotube arrays by chemical vapour deposition over iron catalyst and the effect of growth parameters, Applied Surface Science, 255 (2009) 6325-6334.
[19] N. Sano, S. Yamamoto, H. Tamon, Uniform synthesis of multi-walled carbon nanotubes in a stainless steel porous block, Carbon, 50 (2012) 5628-5630.
[20] M. Karwa, Z. Iqbal, S. Mitra, Scaled-up self-assembly of carbon nanotubes inside long stainless steel tubing, Carbon, 44 (2006) 1235-1242.
[21] Y. Yun, R. Gollapudi, V. Shanov, M. J. Schulz, Z. Y. Dong, A. Jazieh, W. R. Heineman, H. B. Halsall, D. K. Y. Wong, A. Bange, Y. Tu, S. Subramaniam, Carbon nanotubes grown on stainless steel to form plate and probe electrodes for chemical/biological sensing, Journal of Nanoscience and Nanotechnology, 7 (2007) 891-897.
[22] C. Masarapu, B. Wei, Direct growth of aligned multiwalled carbon nanotubes on treated stainless steel substrates, Langmuir, 23 (2007) 9046-9049.
[23] D. Q. Duy, H. S. Kim, D. M. Yoon, K. J. Lee, J. W. Ha, Y. G. Hwang, C. H. Lee, T. C. Bach, Growth of carbon nanotubes on stainless steel substrates by DC-PECVD, Applied Surface Science, 256 (2009) 1065-1068.
[24] X. S. Li, G. Y. Zhu, J. S. Dordick, P. M. Ajayan, Compression-modulated tunable-pore carbon-nanotube membrane filters, Small, 3 (2007) 595-599.
[25] N. Halonen, A. Rautio, A. R. Leino, T. Kyllonen, G. Toth, J. Lappalainen, K. Kordas, M. Huuhtanen, R. L. Keiski, A. Sapi, M. Szabo, A. Kukovecz, Z. Konya, I. Kiricsi, P. M. Ajayan, R. Vajtai, Three-Dimensional Carbon Nanotube Scaffolds as Particulate Filters and Catalyst Support Membranes, Acs Nano, 4 (2010) 2003-2008.
[26] C. E. Baddour, F. Fadlallah, D. Nasuhoglu, R. Mitra, L. Vandsburger, J. L. Meunier, A simple thermal CVD method for carbon nanotube synthesis on stainless steel 304 without the addition of an external catalyst, Carbon, 47 (2009) 313-318.
[27] K. Bosnick, L. Dai, Growth Kinetics in a Large-Bore Vertically Aligned Carbon Nanotube Film Deposition Process†, The Journal of Physical Chemistry C, 114 (2009) 7226-7230.
[28] L. Camilli, M. Scarselli, S. Del Gobbo, P. Castrucci, F. Nanni, E. Gautron, S. Lefrant, M. De Crescenzi, The synthesis and characterization of carbon nanotubes grown by chemical vapor deposition using a stainless steel catalyst, Carbon, 49 (2011) 3307-3315.
[29] J. E. Herrera, L. Balzano, A. Borgna, W. E. Alvarez, D. E. Resasco, Relationship between the Structure/Composition of Co—Mo Catalysts and Their Ability to Produce Single-Walled Carbon Nanotubes by CO Disproportionation, Journal of Catalysis, 204 (2001) 129-145.
[30] W. E. Alvarez, B. Kitiyanan, A. Borgna, D. E. Resasco, Synergism of Co and Mo in the catalytic production of single-wall carbon nanotubes by decomposition of CO, Carbon, 39 (2001) 547-558.
[31] N. Hordy, N.-Y. Mendoza-Gonzalez, S. Coulombe, J.-L. Meunier, The effect of carbon input on the morphology and attachment of carbon nanotubes grown directly from stainless steel, Carbon, 63 (2013) 348-357.
[32] Y. Li, Z. Wang, L. Wang, Surface properties of nitrided layer on AISI 316L austenitic stainless steel produced by high temperature plasma nitriding in short time, Applied Surface Science, 298 (2014) 243-250.
[33] N. Karimzadeh, E. G. Moghaddam, M. Mirjani, K. Raeissi, The effect of gas mixture of post-oxidation on structure and corrosion behavior of plasma nitrided AISI 316 stainless steel, Applied Surface Science, 283 (2013) 584-589.
[34] B. Cho, E. Choi, S. Chung, Oxidation-induced stoichiometric and morphological change of oxide films on stainless-steel surfaces, Appl. Phys. A, 69 (1999) 625-630.
[35] B. Cho, S. Chung, K. Kim, T. Kang, C. Park, B. Kim, Direct observation of oxygen-induced structural changes in stainless-steel surfaces, Journal of Vacuum Science &amp; Technology B, 18 (2000) 868-872.
[36] B. Cho, S. Chung, K. Kim, T. Kang, C. Park, B. Kim, Photoemission study of the stainless steel surface interacting with oxygen, Applied Surface Science, 173 (2001) 22-29.
[37] E. P. DeGarmo, J. T. Black, R. A. Kohser, Materials and Processes in Manufacturing, John Wiley & Sons, 2011.
[38] L. Freire, M. A. Catarino, M. I. Godinho, M. J. Ferreira, M. G. S. Ferreira, A. M. P. Simões, M. F. Montemor, Electrochemical and analytical investigation of passive films formed on stainless steels in alkaline media, Cement and Concrete Composites, 34 (2012) 1075-1081.
[39] N. Sato, Basics of Corrosion Chemistry, Green Corrosion Chemistry and Engineering: Opportunities and Challenges, (2012) 1-32.
[40] N. A. Spurr, P. J. Pinhero, D. J. Sordelet, K. R. Hebert, P. A. Thiel, Electrochemical Pitting And Repassivation On Icosahedral AL-CU-FE, And A Comparison With Crystalline Phases, MRS Online Proceedings Library, 553 (1998) null-null.
[41] P. A. Schweitzer, Fundamentals of metallic corrosion: atmospheric and media corrosion of metals, CRC press, 2006.
[42] L. Veleva, M. A. Alpuche-Aviles, M. K. Graves-Brook, D. O. Wipf, Comparative cyclic voltammetry and surface analysis of passive films grown on stainless steel 316 in concrete pore model solutions, Journal of Electroanalytical Chemistry, 537 (2002) 85-93.
[43] Z. Kerner, Á. Horváth, G. Nagy, Comparative electrochemical study of 08H18N10T, AISI 304 and AISI 316L stainless steels, Electrochimica Acta, 52 (2007) 7529-7537.
[44] M. Hashempour, A. Vicenzo, F. Zhao, M. Bestetti, Direct growth of MWCNTs on 316 stainless steel by chemical vapor deposition: Effect of surface nano-features on CNT growth and structure, Carbon, 63 (2013) 330-347.
[45] E. Limpert, W. A. Stahel, M. Abbt, Log-normal distributions across the sciences: keys and clues, BioScience, 51 (2001) 341-352.
[46] E. F. Kukovitsky, S. G. L'vov, N. A. Sainov, V. A. Shustov, L. A. Chernozatonskii, Correlation between metal catalyst particle size and carbon nanotube growth, Chemical Physics Letters, 355 (2002) 497-503.
[47] S. M. Kim, C. L. Pint, P. B. Amama, D. N. Zakharov, R. H. Hauge, B. Maruyama, E. A. Stach, Evolution in Catalyst Morphology Leads to Carbon Nanotube Growth Termination, Journal of Physical Chemistry Letters, 1 (2010) 918-922.
[48] P. B. Amama, C. L. Pint, L. McJilton, S. M. Kim, E. A. Stach, P. T. Murray, R. H. Hauge, B. Maruyama, Role of Water in Super Growth of Single-Walled Carbon Nanotube Carpets, Nano Letters, 9 (2009) 44-49.
[49] W. Cho, M. Schulz, V. Shanov, Growth termination mechanism of vertically aligned centimeter long carbon nanotube arrays, Carbon, 69 (2014) 609-620.
[50] C. P. Huynh, S. C. Hawkins, M. Redrado, S. Barnes, D. Lau, W. Humphries, G. P. Simon, Evolution of directly-spinnable carbon nanotube growth by recycling analysis, Carbon, 49 (2011) 1989-1997.
[51] S. Hofmann, R. Blume, C. T. Wirth, M. Cantoro, R. Sharma, C. Ducati, M. Hävecker, S. Zafeiratos, P. Schnoerch, A. Oestereich, D. Teschner, M. Albrecht, A. Knop-Gericke, R. Schlögl, J. Robertson, State of Transition Metal Catalysts During Carbon Nanotube Growth, The Journal of Physical Chemistry C, 113 (2009) 1648-1656.
[52] E. Teblum, Y. Gofer, C. L. Pint, G. D. Nessim, Role of Catalyst Oxidation State in the Growth of Vertically Aligned Carbon Nanotubes, The Journal of Physical Chemistry C, 116 (2012) 24522-24528.
[53] Y. Lan, Y. Wang, Z. F. Ren, Physics and applications of aligned carbon nanotubes, Advances in Physics, 60 (2011) 553-678.
[54] M. S. Dresselhaus, A. Jorio, M. Hofmann, G. Dresselhaus, R. Saito, Perspectives on Carbon Nanotubes and Graphene Raman Spectroscopy, Nano Letters, 10 (2010) 751-758.
[55] A. C. Ferrari, J. C. Meyer, V. Scardaci, C. Casiraghi, M. Lazzeri, F. Mauri, S. Piscanec, D. Jiang, K. S. Novoselov, S. Roth, A. K. Geim, Raman Spectrum of Graphene and Graphene Layers, Physical Review Letters, 97 (2006) 187401.
[56] R. Schonfelder, F. Aviles, A. Bachmatiuk, J. V. Cauich-Rodriguez, M. Knupfer, B. Buchner, M. H. Rummeli, On the merits of Raman spectroscopy and thermogravimetric analysis to assess carbon nanotube structural modifications, Applied Physics a-Materials Science & Processing, 106 (2012) 843-852.
[57] G. F. Zhong, J. H. Warner, M. Fouquet, A. W. Robertson, B. A. Chen, J. Robertson, Growth of Ultrahigh Density Single-Walled Carbon Nanotube Forests by Improved Catalyst Design, Acs Nano, 6 (2012) 2893-2903.

1. A method of preparing a catalyst for the synthesis of carbon nanomaterials, the method comprising the steps of:
(a) providing a steel alloy substrate material comprising one or more transition metals and an oxidation barrier coating; and
(b) heating the substrate material in an oxidizing environment to provide the catalyst, whereby the oxidation barrier coating is at least partially broken down so as to expose the one or more transition metals, said one or more transition metals capable of catalyzing the synthesis of a carbon nanomaterial on a surface of the substrate.

2. The method of claim 1, wherein the steel alloy substrate material is a stainless steel.

3. The method of claim 2, wherein the stainless steel is AISI 316 stainless steel.

4. The method of claim 2, wherein the stainless steel comprises C, Si, Mn, P, S, Ni, Cr, Mo, and Fe.

5. The method of claim 4, wherein the stainless steel further comprises Cu and N.

6. The method of claim 2, wherein the stainless steel comprises at least about 10.5 wt % Cr.

7. The method of claim 1, wherein the oxidation barrier coating comprises chromium oxide.

8. The method of claim 1, wherein the step of heating is carried out at a temperature in the range of about 600° C. to about 1000° C. for a time in the range from about 10 seconds to about 30 minutes.

9. The method of claim 8, wherein the step of heating is carried out at a temperature in the range from about 700° C. to about 900° C.

10. The method of claim 9, wherein the step of heating is carried out at about 800° C. for about 1 minute.

11. The method of claim 8, wherein the step of heating is carried out at about 1000° C. for a time in the range from about 10 seconds to 1 minute.

12. The method of claim 1, wherein the oxidizing environment is air.

13. The method of claim 1, wherein the oxidizing environment is a gaseous environment comprising one or more of O₂, O₃, and a mixture of CO₂ and water vapor.

14. The method of claim 1, wherein the step of heating increases surface roughness of the steel alloy substrate material.

15. The method of claim 14, wherein rms surface roughness increases to a value in the range from about 25 nm to about 33 nm.

16. The method of claim 1, wherein the step of heating increases a mass concentration of oxygen of the substrate surface.

17. The method of claim 16, wherein the mass concentration of oxygen increases to about 1%.

18. The method of claim 1, wherein the steel alloy substrate material comprises a form selected from the group consisting of block, wire, cloth, tubing, plate, and mesh.

19. The method of claim 1 that does not include one or more steps selected from the group consisting of: the use of heat treatment for longer than 30 minutes, plasma treatment, laser treatment, acid etching, and calcination.

20. The method of claim 1, further comprising the step of cleaning a surface of the steel alloy substrate material.

21. The method of claim 1, further comprising, after the step of heating, the step of storing the catalyst material in an oxygen-free environment.

22. The method of claim 21, wherein the catalyst material is sealed in a gas-tight container comprising nitrogen gas or argon gas.

23. The method of claim 1, wherein the catalyst is suitable for catalyzing the synthesis of multi-walled carbon nanotubes.

24. The method of claim 23, wherein the catalyst is suitable for catalyzing the synthesis of vertically aligned arrays of carbon nanotubes.

25. The method of claim 23, wherein the catalyst determines the diameter of carbon nanotubes synthesized with the catalyst.

26. A method of synthesizing a carbon nanomaterial, the method comprising exposing a catalyst produced by the method of claim 1 to a carbonaceous feedstock, whereby a carbon nanomaterial is synthesized.

27. The method of claim 26, wherein the catalyst is exposed to a pyrolytically gasified hydrocarbon polymer at a temperature of about 800° C.

28. The method of claim 26, wherein multi-walled carbon nanotubes are synthesized.

29. A catalyst for synthesis of a carbon nanomaterial, the catalyst made by the method of claim 1.
